(19) United States
(12) Patent Application Publication
(10) Pub. No.: US 2013/0280098 A1
(43) Pub. Date: Oct. 24, 2013

(54) MECHANICAL PROTECTION METHOD AND DEVICE

(71) Applicant: Frederic Ferdinand Jacques Batlle, Lons (FR)

(72) Inventor: Frederic Ferdinand Jacques Batlle, Lons (FR)

(73) Assignee: TURBOMECA, Bordes (FR)

(21) Appl. No.: 13/977,924

(22) PCT Filed: Jan. 3, 2012
(86) PCT No.: PCT/FR2012/050001

§ 371 Date: Jul. 2, 2013

(30) Foreign Application Priority Data
Jan. 5, 2011 (FR) 1150066

(51) Int. Cl. F04B 49/00

(52) U.S. Cl. CPC F16D 9/00
USPC 417/1

(57) ABSTRACT

A device and method for providing mechanical protection, and in particular to a mechanical protection device including a transmission shaft with a resonant frequency in bending that corresponds to a predetermined rotary overspeed of the transmission shaft, the transmission shaft being insufficiently damped to avoid breakage of the transmission shaft as a result of the resonance in bending. In the mechanical protection method, the transmission shaft breaks as a result of this resonance in bending.

The present invention relates to a mechanical protection device, and in particular to a device providing mechanical protection against overspeed.

In order to protect devices against mechanical overloads, the person skilled in the art has known for a long time about protection devices in which an element in a mechanical drivetrain is sacrificed in the event of an overload so as to avoid more severe damage downstream from the drivetrain. Usually, such devices are designed to provide protection against excessive forces or torques. By way of example, United States patents U.S. Pat. No. 4,313,712 and U.S. Pat. No. 6,042,292 disclose devices providing mechanical protection against excessive radial forces on rotary shafts. Nevertheless, those known sacrificial devices present the drawback of not providing protection against overspeeds. In many situations, overspeed can lead to as much as damage or even more than excessive force or torque. In particular, in certain machines, such as turbine engines, for example, overspeed may lead to a positive feedback phenomenon leading to a progressive increase in speed up to destruction of the machine.

International patent application WO 2008/101876 discloses a mechanical protection device including a transmission shaft having a resonant frequency in bending that corresponds to a predetermined rotary overspeed of the transmission shaft. In that device, resonance in bending of the transmission shaft serves to absorb the power transmitted in rotation by the transmission shaft, thereby preventing the overspeed being exceeded. Nevertheless, that is possible only if the power available is limited and the damping of the shaft in bending suffices to dissipate all of the available power. If the available power is in danger of increasing with the opposing torque, then the bending resonance of the shaft will not suffice to overcome it.

The present invention seeks to remedy those drawbacks.

This object is achieved by the fact that the damping of the transmission shaft is insufficient to avoid breakage as a result of said resonance in bending. The transmission shaft thus forms a sacrificial element that interrupts the mechanical drivetrain in the event of overspeed.

By means of these provisions, it is possible to obtain effective protection against overspeed that is accurately predetermined, even when the power being transmitted is not limited.

Advantageously, said resonant frequency in bending corresponds to a first bending mode. Thus, the first resonant frequency reached during progressive acceleration of the transmission shaft is the frequency at which the shaft breaks.

The invention also provides a machine including a drive shaft, a feed pump, in particular a fuel feed pump, and a mechanical protection device of the invention, wherein the transmission shaft connects the drive shaft to the feed pump in order to actuate the feed pump. Thus, breakage of the transmission shaft in the event of overspeed of the drive shaft interrupts actuation of the feed pump, and can therefore serve to stop the machine.

Advantageously, said drive shaft is coupled to a turbine that is configured to be actuated by the expansion of a fluid heated by combustion of the fuel delivered by the feed pump. Thus, in the event of overspeed of the turbine, and thus of the drive shaft and of the transmission shaft, breakage of the transmission shaft interrupts the feed of fuel to the machine, thereby causing the turbine to stop. Combustion may be internal or external. Thus, the turbine may be a gas turbine actuated directly by the gas resulting from combustion of the fuel, or a steam turbine actuated by a fluid that is heated indirectly by the combustion of the fuel.

The invention also provides a vehicle, in particular an aircraft, including a machine of the invention. For example, the machine may be a turbo-shaft engine of a rotary wing aircraft.

The invention also provides a mechanical protection method involving breaking a transmission shaft by resonance in bending of the shaft at a predetermined rotary overspeed.

The invention can be well understood and its advantages appear better on reading the following detailed description of an embodiment given by way of non-limiting example. The description refers to the accompanying drawings, in which:

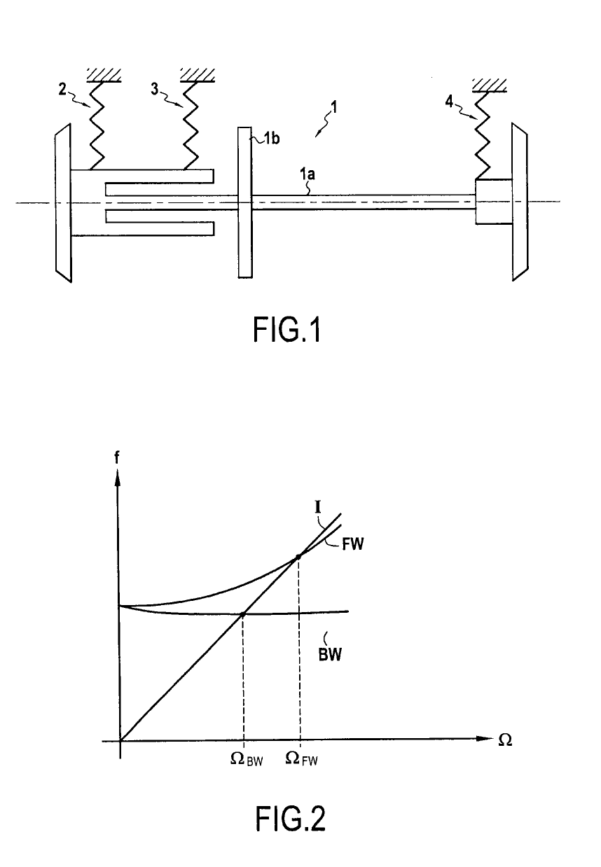

FIG. 1 illustrates a model of a transmission shaft of a mechanical protection device in an embodiment of the invention;

FIG. 2 is a Campbell diagram of the FIG. 1 transmission shaft;

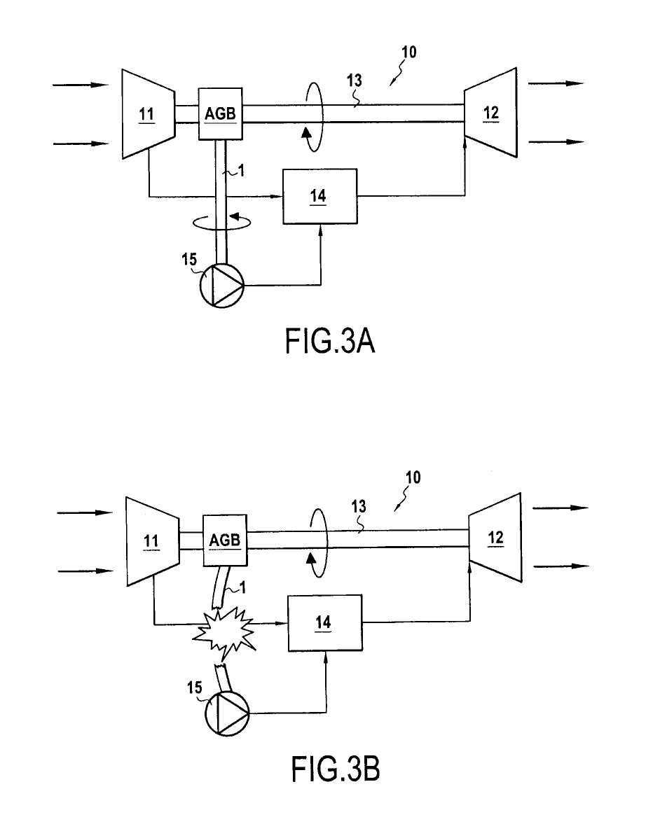

FIG. 3A is a diagram of a turbine engine including the FIG. 1 mechanical protection device; and

FIG. 3B is a diagram of the FIG. 3A turbine engine during breakage of the transmission shaft of the mechanical protection device.

FIG. 1 shows a model of a transmission shaft 1 for a mechanical protection device in an embodiment of the invention. The transmission shaft 1 is modeled as a Jeffcott rotor comprising a stem 1a and a central disk 1b that are secured to each other and supported by elastically-mounted bearings 2, 3, and 4. The stem 1a is itself elastic. The transmission shaft 1 is thus a dynamic system presenting a plurality of resonant frequencies, including resonances in bending between the bearings 2, 3, and 4. Each bending mode of the transmission shaft 1 presents two resonant frequencies, a forward whirl (FW) resonant frequency and a backward whirl (BW) resonant frequency. Each of these two frequencies follows a curve as a function of the speed of rotation of the transmission shaft 1. FIG. 2 shows curves FW and BW representing respectively the resonant frequency of the first forward whirl mode and the resonant frequency of the first backward whirl mode, as a function of the speed of rotation of the shaft 1. On the same graph, the straight line I shows a frequency ratio fᵣ corresponding to the speed of rotation Ω of the shaft 1. Mainly because of unbalances, forces are exerted, even inadvertently, on the shaft rotating at this frequency fᵣ. The backward whirl bending mode cannot be excited by unbalances. However, when the frequency ratio fᵣ coincides with the forward whirl resonant frequency, i.e. in the graph of FIG. 2, at the critical speed of rotation Ω_{FW}, the shaft 1 enters into resonance. Although a real transmission shaft 1 can present a certain amount of inherent damping, such inherent damping is very limited and normally does not suffice to dissipate the energy of the vibration induced in the shaft 1 at such a speed of rotation. The amplitude of the bending vibration of the shaft 1 therefore diverges until the shaft 1 breaks.

In the mechanical protection device shown, the shaft 1 is calibrated so that the forward whirl critical speed of rotation Ω_{FW} of the first bending mode corresponds to a predetermined overspeed, e.g. by way of example 120% of the nominal speed of rotation Ωₙ the shaft 1. Thus, if the transmission shaft 1 reaches this overspeed Ω_{FW}, the overspeed will lead to catastrophic resonance of the transmission shaft 1, thereby breaking the transmission shaft 1 and thus interrupting the drivetrain.

The transmission shaft 1 thus operates as a sacrificial mechanical protection device, not against excess force or excess torque, but against excess speed. An example of an application for such a mechanical protection device against overspeed is shown in FIG. 3A. In this example, a device of the invention is used to protect a turbine engine 10 against overspeed. The turbine engine 10 comprises a compressor 11 and a turbine 12 that are connected together by a drive shaft 13, together with a combustion chamber 14 that is fed with fuel by a feed pump 15. Air compressed by the compressor 12 is delivered to the combustion chamber 14, and the expansion of hot combustion gas through the turbine 12 serves to actuate the drive shaft 13 with a large power surplus over the power required for actuating the compressor 11. The drive shaft 13 can thus be connected to other mechanical devices in order to actuate them, such as a helicopter rotor, for example.

In the turbine engine 10, the transmission shaft 1 is coupled to the drive shaft 13 via an accessory gearbox AGB. The transmission shaft 1 is also coupled to the feed pump 15 in order to actuate it. In this way, in operation, power is taken from the drive shaft 13 via the transmission shaft 1 in order to feed the combustion chamber 14 with fuel.

If a predetermined overspeed of the drive shaft 13 is reached, the transmission shaft 1 reaches its critical speed of rotation Ω_{FW} and breaks as a result of bending resonance. The feed pump 15 is then no longer actuated, and the delivery of fuel to the combustion chamber 14 stops. Since the turbine engine 10 is no longer fed with fuel, it ceases to produce power for actuating the drive shaft 13, and as a result the drive shaft 13 is prevented from running away.

In an example application, the drive shaft 13 of the turbine engine 10 may have a nominal speed of 30,000 revolutions per minute (rpm), and the mechanical protection device may be set to stop feeding fuel at an overspeed of 120% of the nominal speed, i.e. at 36,000 rpm. If the transmission shaft 1 is driven by the drive shaft 13 with a gear ratio of ⅓, it should therefore be designed to break at a critical speed of 12,000 rpm, i.e. with a forward whirl resonant frequency Ω_{FW} of 200 hertz (Hz), at the first bending mode of the shaft.

Although the present invention is described above with reference to specific embodiments, it is clear that various modifications and changes may be applied to those embodiments without going beyond the general scope of the invention as defined by the claims. Consequently, the description and the drawings should be considered as being illustrative rather than restrictive.

1-12. (canceled)

13. A mechanical protection device comprising:
a transmission shaft having a resonant frequency in bending corresponding to a predetermined rotary overspeed of the transmission shaft;
wherein damping of the transmission shaft is insufficient to avoid breakage of the transmission shaft resulting from resonance in bending.

14. A mechanical protection device according to claim 13, wherein the resonant frequency in bending corresponds to a first bending mode.

15. A machine comprising:
a drive shaft;
a feed pump; and
a mechanical protection device comprising a transmission shaft having a resonant frequency in bending corresponding to a predetermined rotary overspeed of the transmission shaft;
wherein damping of the transmission shaft is insufficient to avoid breakage of the transmission shaft resulting from resonance in bending; and
wherein the transmission shaft connects the drive shaft to the feed pump to actuate the feed pump.

16. A machine according to claim 15, wherein the feed pump is a fuel feed pump.

17. A machine according to claim 16, wherein the drive shaft is coupled to a turbine configured to be actuated by expansion of a fluid heated by combustion of fuel.

18. A machine according to claim 15, wherein the resonant frequency in bending corresponds to a first bending mode.

19. A vehicle comprising:
a machine comprising:
a drive shaft;
a feed pump; and
a mechanical protection device comprising a transmission shaft having a resonant frequency in bending corresponding to a predetermined rotary overspeed of the transmission shaft;
wherein damping of the transmission shaft is insufficient to avoid breakage of the transmission shaft resulting from resonance in bending; and
wherein the transmission shaft connects the drive shaft to the feed pump to actuate the feed pump.

20. A vehicle according to claim 19, wherein the resonant frequency in bending corresponds to a first bending mode.

21. A vehicle according to claim 19, wherein the feed pump is a fuel feed pump.

22. A vehicle according to claim 21, wherein the drive shaft is coupled to a turbine configured to be actuated by expansion of a fluid heated by combustion of fuel.

23. An aircraft comprising:
a machine comprising:
a drive shaft;
a feed pump; and
a mechanical protection device comprising a transmission shaft having a resonant frequency in bending corresponding to a predetermined rotary overspeed of the transmission shaft;
wherein damping of the transmission shaft is insufficient to avoid breakage of the transmission shaft resulting from resonance in bending; and
wherein the transmission shaft connects the drive shaft to the feed pump to actuate the feed pump.

24. An aircraft according to claim 23, wherein the resonant frequency in bending corresponds to a first bending mode.

25. An aircraft according to claim 23, wherein the feed pump is a fuel feed pump.

26. An aircraft according to claim 25, wherein the drive shaft is coupled to a turbine configured to be actuated by expansion of a fluid heated by combustion of fuel.

27. A mechanical protection method comprising:
breaking a transmission shaft by resonance in bending of the transmission shaft at a predetermined rotary overspeed.

28. A mechanical protection method according to claim 27, wherein the resonance corresponds to a first bending mode of the transmission shaft.

29. A mechanical protection method according to claim 27, wherein the transmission shaft transmits rotation from a drive shaft to a feed pump.

30. A mechanical protection method according to claim 29, wherein the feed pump feeds fuel for combustion to deliver heat energy serving to cause the drive shaft to rotate.

31. A mechanical protection method according to claim 30, wherein the drive shaft is actuated by a turbine, the turbine being actuated in turn by expansion of a fluid heated by the combustion.
